(19) United States
(12) Patent Application Publication
(10) Pub. No.: US 2015/0221414 A1
(43) Pub. Date: Aug. 6, 2015

(54) POWER ADAPTER FOR A COMPUTING DEVICE

(71) Applicant: GOOGLE INC., Mountain View, CA (US)

(72) Inventors: Yoshimichi Matsuoka, Cupertino, CA (US); Aaron Leiba, San Francisco, CA (US)

(73) Assignee: GOOGLE INC., Mountain View, CA (US)

(21) Appl. No.: 13/692,422

(22) Filed: Dec. 3, 2012

Related U.S. Application Data
(60) Provisional application No. 61/664,965, filed on Jun. 27, 2012.

(51) Int. Cl. H01B 7/04

(52) U.S. Cl. CPC H01B 7/041

(57) ABSTRACT

In accordance with aspects of the disclosure, a power adapter for a computing device having at least one processor may include a power interface for supplying power to the computing device including the at least one processor via a multi-functional cable interposed between the power adapter and the computing device. The power adapter may include a network interface for communicating with the at least one processor via the multi-functional cable and a remote server over a wireless network. The multi-functional cable may be configured with a first transitory medium for supplying power to the computing device from the power interface and a second transitory medium for transferring information between the computing device and the network interface.

### RELATED APPLICATIONS

This application claims priority to and the benefit of U.S. Provisional Patent Application Ser. No. 61/664,965 filed Jun. 27, 2012, which is incorporated herein by reference in its entirety.

### TECHNICAL FIELD

This description relates to a power adapter for a computing device.

### BACKGROUND

Portable computing devices, such as laptops, may be configured with radio transceivers and antennas for communicating with various wireless networks including the Internet. Typically, users may prefer to purchase smaller, slimmer laptops with built-in radio capability, such as Wi-Fi and 3G/4G radio capability. However, having a strong antenna in a laptop could be considered hazardous to the user, because in some instances, the user's body could absorb harmful energy from the laptop when exposed to high-energy radio frequencies emanating from the radio transceivers in the laptop. As such, there currently exists a need to reduce a user's possible exposure to harmful radio frequencies emanating from a laptop.

### SUMMARY

In accordance with aspects of the disclosure, a power adapter for a computing device having at least one processor may include a power interface for supplying power to the computing device including the at least one processor via a multi-functional cable interposed between the power adapter and the computing device. The power adapter may include a network interface for communicating with the at least one processor via the multi-functional cable and a remote server over a wireless network. The multi-functional cable may be configured with a first transitory medium for supplying power to the computing device from the power interface and a second transitory medium for transferring information between the computing device and the network interface.

In accordance with aspects of the disclosure, a system including a computing device having at least one processor may include a multi-functional cable including a first transitory medium for supplying power to the computing device and a second transitory medium for transferring information with the computing device. The system may include a power adapter including a power interface for supplying power to the computing device including the at least one processor via the first transitory medium of the multi-functional cable when interposed between the computing device and the power adapter. The power adapter may include a network interface for communicating with the at least one processor via the second transitory medium of the multi-functional cable and a remote server via a wireless network. The multi-functional cable may be configured to electrically connect the computing device to the power interface of the power adapter via the first transitory medium for supplying power to the computing device from the power interface. The multi-functional cable may be configured to electrically connect the computing device to the network interface of the power adapter via the second transitory medium for transferring information between the computing device and the network interface.

In accordance with aspects of the disclosure, a method may include assembling a power adapter with a power interface and a network interface for use by a computing device having at least one processor and assembling a multi-functional cable having a plurality of transitory mediums for electrically connecting between the power adapter and the computing device. The multi-functional cable may provide for supplying power to the computing device including the at least one processor from the power interface of the power adapter via a first transitory medium of the multi-functional cable when interposed between the computing device and the power adapter. The multi-functional cable may provide for communicating between the at least one processor of the computing device and the network interface of the power adapter via a second transitory medium of the multi-functional cable. The multi-functional cable may provide for communicating between a remote server and the computing device via the second transitory medium of the multi-functional cable and the network interface of the power adapter over a wireless network.

The details of one or more implementations are set forth in the accompanying drawings and the description below. Other features will be apparent from the description and drawings, and from the claims.

### BRIEF DESCRIPTION OF THE DRAWINGS

FIGS. 1A-1E are diagrams illustrating example systems for implementing example power adapters for a computing device including a portable computing device.

FIG. 2 is a process flow chart illustrating an example method for providing an example power adapter for a computing device.

FIG. 3 is a block diagram illustrating an example power adapter suitable for implementing embodiments of the disclosure.

FIG. 4 is a block diagram illustrating an example computer system suitable for implementing embodiments of the disclosure.

### DETAILED DESCRIPTION

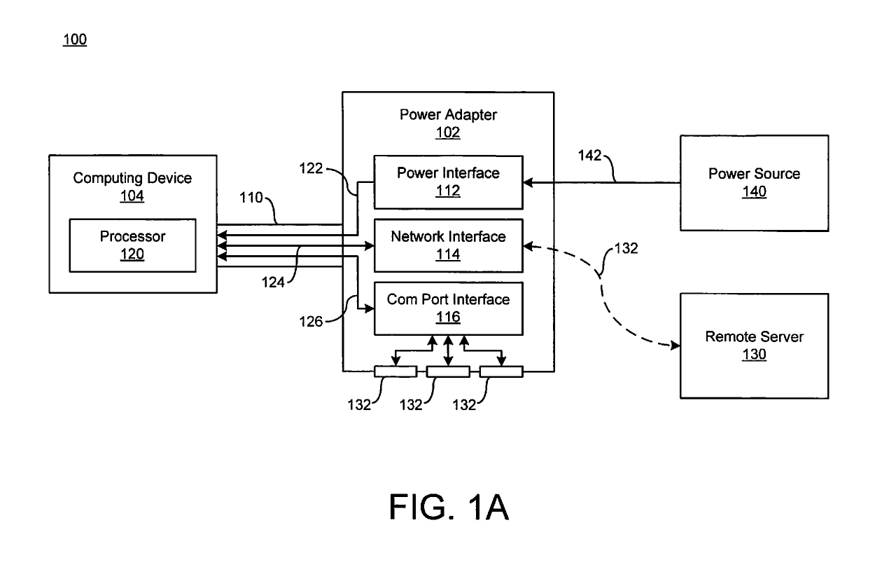

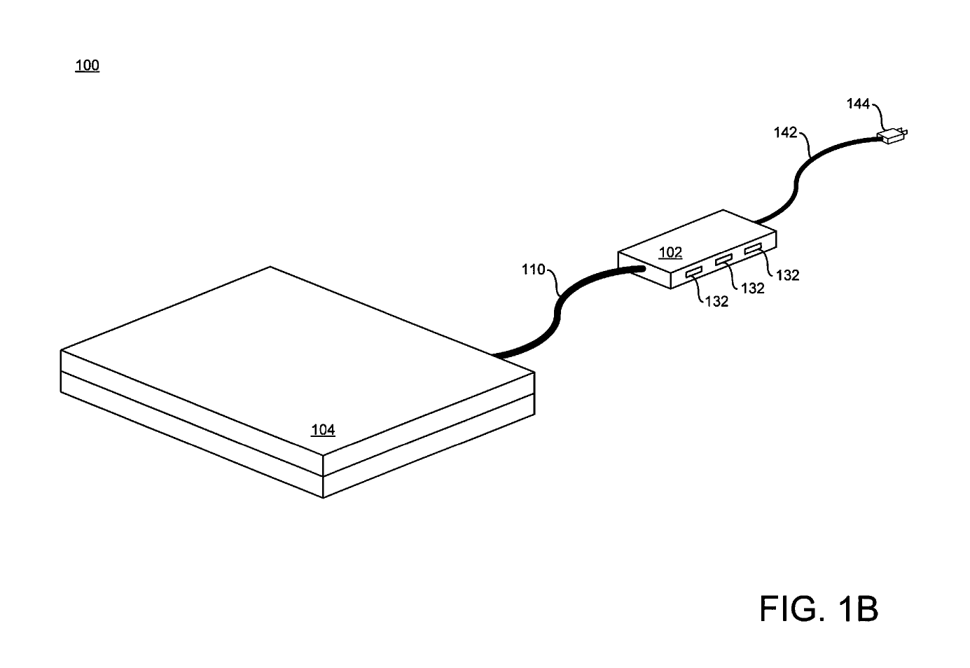

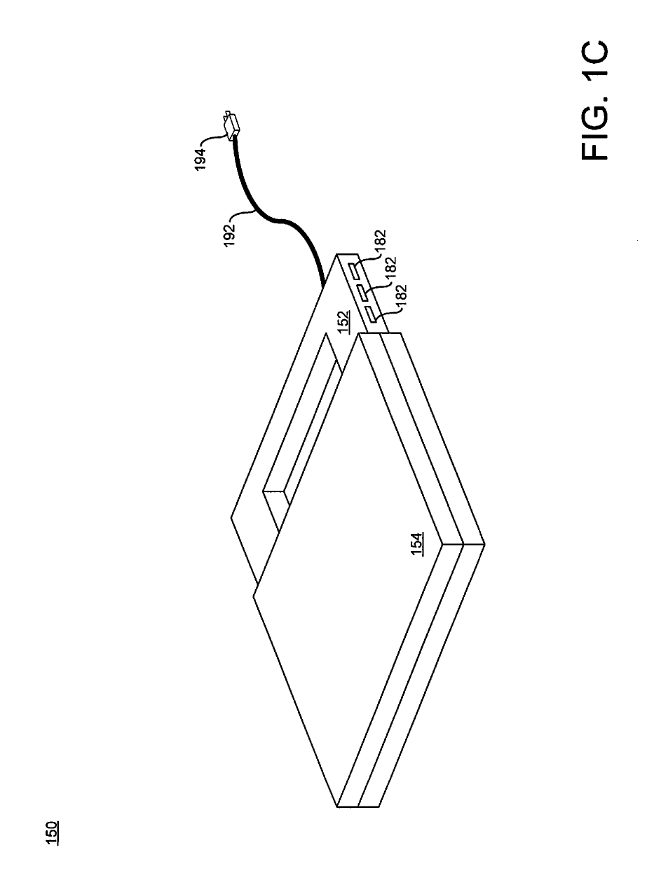

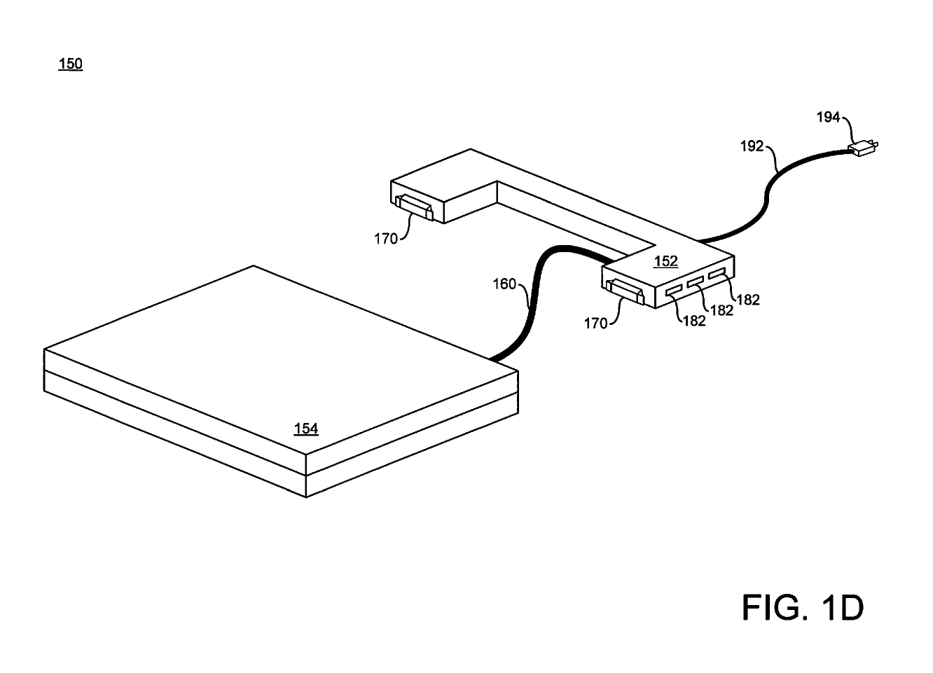

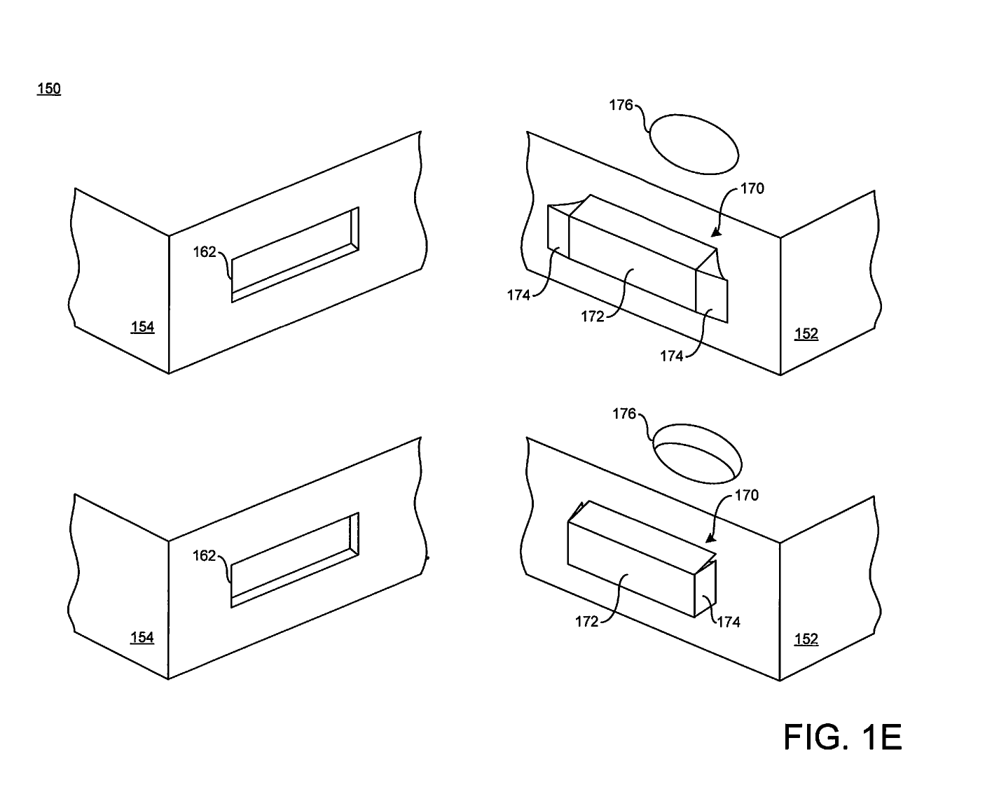

FIGS. 1A-1E are diagrams illustrating example systems for implementing example power adapters for a computing device. In particular, FIG. 1A shows a block diagram of an example system 100 for implementing an example power adapter 102 for a computing device 104. FIG. 1B shows a schematic diagram of the example system 100 for implementing the example power adapter 102 for the computing device 104, such as a portable computing device. FIGS. 1C-1D show schematic diagrams of another example system 150 for implementing the example power adapter 102 for the computing device 104, such as a portable computing device. FIG. 1E shows a schematic diagram of the another example system 150 for implementing one or more retention features 170 that may be configured for attachment to a side of the power adapter 152.

In the example of FIG. 1A, the system 100 may include the computing device 104 having at least one processor 120. The computing device 104 may include an enclosure having a specialized chassis for integrating one or more computing components within the computing device 104, such as, for example, the at least one processor 120, system memory, static storage memory, one or more disk drives, one or more network interface components, display component, one or more user input components, one or more image capture components, and a bus or other communication mechanism for interconnecting the subsystems and components. The enclosure may be configured to provide power to the integrated computing components via a battery, power cable, etc.

In an embodiment, the computing device 104 may be implemented using any appropriate combination of hardware and/or software configured for interfacing with a user including a user device, a user interface (UI) device, a user terminal, a client device, or a customer device. For example, as shown in FIG. 1B, the computing device 104 may be implemented as a portable computing device, such as a laptop computer, a notebook computer, a tablet computer, and/or a personal digital assistant (PDA). In another example, the computing device 104 may be implemented as some other type of computing device adapted for interfacing with a user, such as, for example, a personal computer (PC). In another example, the computing device 104 may be implemented as a portable communication device (e.g., a mobile communication device including mobile cellular phone, a smart phone, a wireless phone, etc.) adapted for interfacing with a user and for wireless communication over one or more networks, such as, for example, one or more mobile communication networks including WLAN, Wi-Fi, etc. and the Internet.

In an implementation, the portable computing device 104 may comprise a laptop that may utilize the power adapter 102 having a power interface 112 adapted for converting an alternating current (AC) power signal to a direct current (DC) power signal for use by the portable computing device 104 including the at least one processor 120. In an example, the power adapter 102 may include one or more radio components including one or more transceivers, transmitters, receivers, and/or antennas, and one or more communication ports including one or more universal serial bus (USB) ports, Ethernet ports, firewire ports, serial ports, parallel ports, and digital visual interface (DVI) ports. By positioning the radio components and the communication ports in the power adapter 102, the portable computing device 104 may be made smaller and possibly more safe, since the radio frequencies may no longer emanate or radiate directly from the portable computing device 104, and instead the radio frequencies may emanate or radiate from the power adapter 102, which may be positioned away from (i.e., disposed away from or extended away from) the portable computing device 104 by a distance of a length of an interposed cable so that the emanating or radiating radio frequencies may be less likely to harm the user. As such, the power adapter 102 may be positioned away from the user's body so as to be safer, and the power adapter 102 may be positioned to receive better antenna reception since a location of the power adapter 102 may be easily moved around. Further, as provided herein, the power adapter 102 may be attached to the portable computing device 104 to serve as a handle for improved portability and mobility of the portable computing device 104 by a user.

In the example of FIG. 1A, the system 100 may include a multi-functional cable 110 comprising a first transitory medium 122 for supplying power to the computing device 104 and a second transitory medium 124 for transferring information with the computing device 104. In an implementation, the multi-functional cable 110 may be configured to enclose at least the first and second transitory mediums 122, 124, and the first transitory medium 122 may be separate from the second transitory medium 124. For example, the first transitory medium 122 may comprise first wiring materials within the multi-functional cable 110 that is disposed adjacent to the second transitory medium 124 that may comprise second wiring materials within the multi-functional cable 110 that is separate from the first wiring materials. In another example, the first wiring materials may comprise different wiring materials than the second wring materials. For instance, the first wiring materials may comprise a twisted copper pair of wires coated with an insulation material to thereby create separation from the second wiring materials, and the second wiring materials may comprise an inner communication wire surrounded by a shielding wire and further coated with an insulation material to thereby create separation from the first wiring materials. As such, the first and second transitory mediums 122, 124 may comprise separate and/or different wiring materials that are disposed adjacent to each other within the multi-functional cable 110.

In another implementation, the first transitory medium 122 may include first wiring for supplying power to the computing device 104 including the at least one processor 120 from the power interface 112 of the power adapter 102 via the multi-functional cable 110, and the second transitory medium 124 may include second wiring for transferring information between the computing device 104 including the at least one processor 120 and the network interface 114 of the power adapter 102 via the multi-functional cable 110. In another implementation, the first transitory medium 122 may include first shielded wiring, and the second transitory medium 124 may include second shielded wiring, wherein the first transitory medium 122 may be shielded separately from the second transitory medium 124.

In the example of FIG. 1A, the system 100 may include the power adapter 102 comprising a power interface 112 for supplying power to the computing device 104 including the at least one processor 120 via the first transitory medium 122 of the multi-functional cable 110 when interposed between the computing device 104 and the power adapter 102. In an implementation, referring to FIG. 1B, the power adapter 102 may be configured to be disposed or extended away from the computing device 104 by a distance less than or equal to a length of the multi-functional cable 110. In an example, the power adapter 102 may be configured to be disposed or extended away from the computing device 104 by a distance of at least 10 inches so as to improve safety for the user when the power adapter 102 is transmitting and/or receiving RF communication signals that may be considered harmful for the user. As such, in various implementations, the length of the multi-functional cable 110 may comprise any length that allows for disposing the power adapter 102 away from the computing device 104 so as to improve safety for the user. For example, the length of the multi-functional cable 110 may comprise a length of approximately 10 inches or any length between a range of 0 inches and 36 inches or even greater than 36 inches, without departing from the scope of the disclosure.

In an implementation, the multi-functional cable 110 electrically connects the computing device 104 to the power interface 112 of the power adapter 102 via the first transitory medium 122 for supplying power to the computing device 104 from the power interface 112. The power interface 112 of the power adapter 102 may be configured as a power converter adapted to transform an alternating current (AC) power signal received from an alternating current (AC) power source 140 via a power cable 142 to a direct current (DC) power signal for supplying to the computing device 104 including the at least one processor 120 via the first transitory medium 122 of the multi-functional cable 110. In an implementation, referring to FIG. 1B, the power adapter 102 may be configured to be disposed or extended away from the power source 140 by a distance less than or equal to a length of the power cable 142. As shown in FIG. 1B, the power cable 142 may include a plug 144 for electrically connecting to the power source 140, such as, for example, a household outlet plug.

In an implementation, the power interface 112 of the power adapter 102 may include a charger or charging component configured for supplying charge power to a power storage component, such as, for example, a battery, of the computing device 104 via the multi-functional cable 110. As such, the power adapter 102 may be configured for supplying charge power to a battery of the computing device 104 via the first transitory medium 122 the multi-functional cable 110.

In the example of FIG. 1A, the power adapter 102 may include a network interface 114 for communicating with the at least one processor 120 of the computing device 104 via the second transitory medium 124 of the multi-functional cable 110 and a remote server 130 via a wireless network 132. As such, in the example of FIG. 1A, the multi-functional cable 110 allows for the at least one processor 120 of the computing device 104 to communicate (e.g., transmit information to and receive information from) with the remote server 130 via the second transitory medium 124, the network interface 114, and the wireless network 132. In various implementations, the wireless network may comprise one or more wireless communication networks adapted to communicate with one or more other wired or wireless networks including the Internet.

In an implementation, the multi-functional cable 110 electrically connects the computing device 104 including the at least one processor 120 to the network interface 114 of the power adapter 102 via the second transitory medium 124 for transferring information between the computing device 104 including the at least one processor 120 and the network interface 114. The network interface 114 of the power adapter 102 may be configured to transmit and receive wired communication signals to and from the computing device 104 including the at least one processor 120 over the second transitory medium 124 of the multi-functional cable 110.

In another implementation, the computing device 104 including the at least one processor 120 of the computing device 104 may be configured to communicate with the remote server 130 via the network interface 114 of the power adapter 102 by transferring information over the second transitory medium 124 of the multi-functional cable 110 to the network interface 114, and the network interface 114 may be configured for transferring the information received from the at least one processor 120 to the remote server 130 over the wireless network 132. The network interface 114 of the power adapter 102 may include one or more communication components including at least one of a transceiver, a transmitter, a receiver, and an antenna to communicate with the remote server 130 over the wireless network 132. The network interface 114 of the power adapter 102 may be configured to transmit and receive wireless radio frequency (RF) communication signals to and from the remote server 130 over the wireless network 132.

In the example of FIG. 1A, the power adapter 102 may include a communication port interface 116 for communicating with the computing device 104 including the at least one processor 120 via the multi-functional cable 110. In an implementation, the multi-functional cable 110 may be configured with a third transitory medium 126 for transferring information between the computing device 104 including the at least one processor 120 and the communication port interface 116 including one or more communication ports 132 such as, for example, one or more of a universal serial bus (USB) port, an Ethernet port, a firewire port, a serial port, a parallel port, and a digital visual interface (DVI) port. In an implementation, referring to FIGS. 1A-1B, the power adapter 102 may include the one or more ports 132 for electrically connecting one or more peripheral devices, wherein the computing device 104 including the at least one processor 120 may be configured to communicate with the one or more electrically connected peripheral devices via the third transitory medium 126 of the multi-functional cable 110 and the communication port interface 116 of the power adapter 102.

In an implementation, the multi-functional cable 110 may be configured to enclose the first, second, and third transitory mediums 122, 124, 126, and the third transitory medium 126 may be separate from the first and second transitory mediums 122, 124. The third transitory medium 126 may include third wiring for transferring information between the computing device 104 including the at least one processor 120 and the communication port interface 116 of the power adapter 102 via the multi-functional cable 110. The third transitory medium 126 may include third shielded wiring, and the third transitory medium 126 may be shielded separately from the first and second transitory mediums 122, 124.

Referring to the example of FIGS. 1C-1D, the system 150 may include the computing device 154 and the power adapter 152. In particular, FIG. 1C shows the power adapter 152 attached to the computing device 154, and FIG. 1D shows the power adapter 152 detached from the computing device 154. In an implementation, the power adapter 152 may be electrically connected to the portable computing device 154 via another multi-functional cable 160, in a manner, for example, as provided in reference to FIGS. 1A-1B. As such, it should be appreciated that the scope and functionality of the power adapter 152, the computing device 154, and the multi-functional cable 160 of FIGS. 1C-1D are similar in scope and functionality to the respective power adapter 102, computing device 104, and multi-functional cable 110, as described in reference to FIG. 1A-1B

As shown in FIG. 1C, the power adapter 152 may be configured for attaching to the computing device 154, which may comprise, in an example, a portable computing device. When attached, the power adapter 154 may be configured to serve as a handle for carrying the computing device 154 by a user. As such, the power adapter 152 when securely attached to the computing device 154 may provide a handle for carrying the computing device 154 by a user. As shown in FIG. 1C, for example, the power adapter 152 may be configured as a rigid carrying implement in the form of a handle for improved mobility of the computing device 154.

As shown in FIG. 1D, the power adapter 152 may be configured for detaching from the computing device 154. When detached, the power adapter 152 may be configured to be disposed or extended away from the computing device 154 by a distance less than or equal to a length of the multi-functional cable 160.

In an implementation, the power adapter 152 may include a retention mechanism, such as, for example, one or more retention features 170 for mechanically connecting one or more portions of the power adapter 152 to one or more portions of the portable computing device 154. In another implementation, the computing device 154 may include a receptacle mechanism, such as, for example, one or more receptacle features for receiving the one or more retention features 170. For example, the retention features 170 may be configured to slidably engage the one or more receptacle features for secure attachment of the power adapter 152 to the computing device 154. In another example, the receptacle features may be configured as recessed slots that are contoured to receive the retention features 170 in a highly cohesive manner of engagement.

In an implementation, as shown in FIG. 1E, the one or more retention features 170 may be configured for attachment to a side of the power adapter 152. Each of the one or more retention features 170 may include a base portion 172 that extends from the side of the power adapter 152 so as to communicate with one or more receptacle features 162 of the portable computing device 154 that are configured as recesses formed in a side of the portable computing device 154.

As further shown in FIG. 1E, each of the one or more retention features 170 may include retractable retaining elements 174 that may be retracted into sides of the base portion 172 upon pressing of a triggering mechanism 176, such as an actuating button, by a user. In an implementation, each of the one or more retention features 170 may include a spring-loaded mechanism that provides for re-extending of the retaining elements 174 from within the base portion 172 upon release of the triggering mechanism 176 by the user. As such, in this implementation, to attach the power adapter 152 to the portable computing device 154, a user may press the triggering mechanism 176 so as to retract the retaining elements 174. In an example, while the retaining elements 174 are retracted within the base portion 172, the user may couple the base portion 172 of the retention features 170 with corresponding ones of the receptacle features 162 of the portable computing device 154. In another example, while holding the power adapter 152 adjacent to the portable computing device 154, the user may release the triggering mechanism 176 so as to re-extend the retaining elements 174 from the base portion 172 of the retention features 170 to thereby couple the retention features 170 of the power adapter 152 to the receptacle features 162 of the portable computing device 154.

In an aspect of the disclosure, referring to the example of FIG. 1E, this retention mechanism allows for secure attachment of the power adapter 152 to the portable computing device 154 so that the attached power adapter 152 may be used, for example, as a handle for carrying by the user.

To simplify explanation, the power adapter 152, the computing device 154, and the multi-functional cable 160 of FIGS. 1C-1D will be described in reference to the system 100 of FIG. 1A. For instance, in an implementation, the multi-functional cable 160 electrically connects the computing device 154 to the power interface 112 of the power adapter 152 via the first transitory medium 122 for supplying power to the computing device 104 from the power interface 112. The power interface 112 of the power adapter 102 may be configured as a power converter adapted to transform an alternating current (AC) power signal received from an alternating current (AC) power source 140 via a power cable 192 to a direct current (DC) power signal for supplying to the computing device 154 including the at least one processor 120 via the first transitory medium 122 of the multi-functional cable 160. As shown in FIGS. 1C-1D, the power cable 192 may include a plug 194 for electrically connecting to the power source 140, such as, for example, a household outlet plug.

Further, in another implementation, the power adapter 152 may include a communication port interface 116 for communicating with the computing device 154 including the at least one processor 120 via the multi-functional cable 160. In another implementation, the multi-functional cable 160 may be configured with a third transitory medium 126 for transferring information between the computing device 154 including the at least one processor 120 and the communication port interface 116 including one or more of a USB port, an Ethernet port, a firewire port, a serial port, a parallel port, and a DVI port. In another implementation, the power adapter 152 may include one or more ports 182 for electrically connecting one or more peripheral devices, wherein the computing device 154 including the at least one processor 120 may be configured to communicate with the one or more electrically connected peripheral devices via the third transitory medium 126 of the multi-functional cable 160 and the communication port interface 116 of the power adapter 152.

In an aspect of the disclosure, the network may be implemented as a single network or a combination of multiple networks. For example, the network may include one or more wireless communications networks adapted for communication with one or more other wired and/or wireless communication networks, such as the Internet. In other examples, the network may include the Internet, one or more intranets, landline networks, wireless networks, and/or one or more other appropriate types of wired and/or wireless communication networks. In various implementations, the power adapter 102 and/or the computing device 104 may be associated with a particular link (e.g., a link, such as a URL (Uniform Resource Locator) to an IP (Internet Protocol) address).

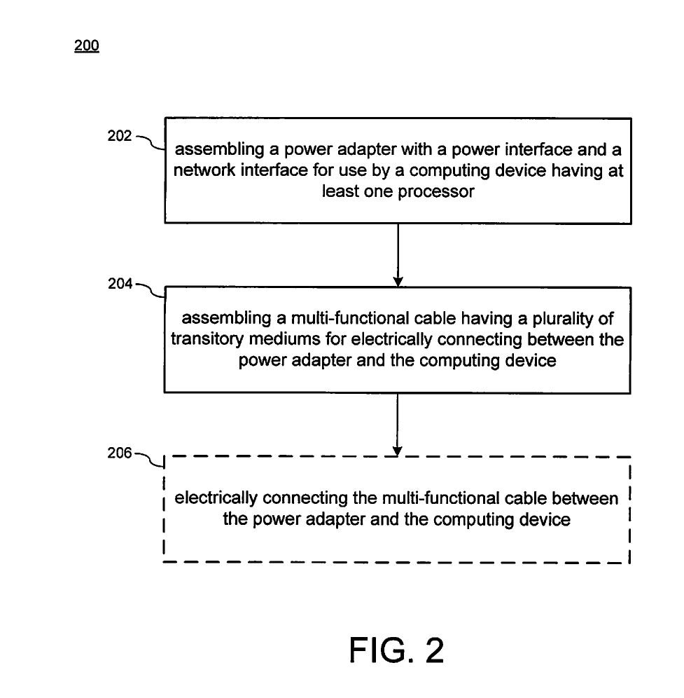

FIG. 2 is a process flow chart illustrating an example method 200 for providing the example power adapters 102, 152 for the example computing devices 104, 154, as described in reference to FIGS. 1A-1D. In the example of FIG. 2, operations 202-208 are illustrated as discrete operations occurring in sequential order. However, it should be appreciated that, in other implementations, two or more of the operations 202-208 may occur in a partially or completely overlapping or parallel manner, or in a nested or looped manner, or may occur in a different order than that shown. Further, additional operations, that may not be specifically illustrated in the example of FIG. 2, may also be included in some implementations, while, in other implementations, one or more of the operations 202-208 may be omitted.

At 202, the method 200 may include assembling a power adapter with a power interface and a network interface for use by a computing device having at least one processor. For example, the method 200 may include assembling the power adapter 102 with the power interface 112 and the network interface 114 for use by the computing device 104 having the at least one processor 120. In another example, the method 200 may include assembling the power adapter 152 with the power interface 112 and the network interface 114 for use by the computing device 154 having the at least one processor 120.

At 204, the method 200 may include assembling a multi-functional cable having a plurality of transitory mediums for electrically connecting between the power adapter and the computing device. For example, the method 200 may include assembling the multi-functional cable 110 having a plurality of transitory mediums 122, 124 for electrically connecting between the power adapter 102 and the computing device 104. In another example, the method 200 may include assembling the multi-functional cable 110 having a plurality of transitory mediums 122, 124 for electrically connecting between the power adapter 152 and the computing device 154.

In an implementation, the multi-functional cable may be configured to provide for supplying power to the computing device including the at least one processor from the power interface of the power adapter via a first transitory medium of the multi-functional cable when interposed between the computing device and the power adapter. For example, the method 200 may include supplying power to the computing device 104 including the at least one processor 120 from the power interface 112 of the power adapter 102 via the first transitory medium 122 of the multi-functional cable 110 when interposed between the computing device 104 and the power adapter 102. In another example, the method 200 may include supplying power to the computing device 154 including the at least one processor 120 from the power interface 112 of the power adapter 152 via the first transitory medium 122 of the multi-functional cable 160 when interposed between the computing device 104 and the power adapter 102.

In an implementation, the multi-functional cable may be configured to provide for communicating between the at least one processor of the computing device and the network interface of the power adapter via a second transitory medium of the multi-functional cable. For example, the method 200 may include communicating with the at least one processor 120 of the computing device 104 from the network interface 114 of the power adapter 102 via the second transitory medium 124 of the multi-functional cable 110. In another example, the method 200 may include communicating with the at least one processor 120 of the computing device 154 from the network interface 114 of the power adapter 152 via the second transitory medium 124 of the multi-functional cable 160.

In an implementation, the multi-functional cable may be configured to provide for communicating between a remote server and the computing device via the second transitory medium of the multi-functional cable and the network interface of the power adapter over a wireless network. For example, the multi-functional cable 110 provides for communicating between the remote server 130 and the computing device 104 via the second transitory medium 124 of the multi-functional cable 110 and the network interface 114 of the power adapter 102 over the wireless network 132. In another example, the multi-functional cable 160 provides for communicating between the remote server 130 and the computing device 154 via the second transitory medium 124 of the multi-functional cable 160 and the network interface 114 of the power adapter 152 over the wireless network 132.

Referring to FIG. 2, at 206, the method 200 may optionally include electrically connecting the multi-functional cable between the power adapter and the computing device (e.g., a portable computing device) having the at least one processor. For example, the method 200 may include electrically connecting the multi-functional cable 110 between the power adapter 102 and the computing device 104 having the at least one processor 120. In another example, the method 200 may include electrically connecting the multi-functional cable 160 between the power adapter 152 and the computing device 154 having the at least one processor 120.

In an implementation, the multi-functional cable may further provide for communicating with the at least one processor of the computing device from a communication port interface of the power adapter via a third transitory medium of the multi-functional cable, wherein the multi-functional cable may be configured with the third transitory medium for transferring information between the computing device and the communication port interface including one or more of a USB port, an Ethernet port, a firewire port, a serial port, a parallel port, and a DVI port.

In an implementation, the multi-functional cable may further provide for supplying charge power to a battery of the computing device via the multi-functional cable from a charger or charging component of the power adapter.

In an implementation, the multi-functional cable may further provide for disposing or extending the power adapter 102, 152 away from the computing devices 104, 154 by a distance of at least a length of the multi-functional cable 110, 160, respectively.

In an implementation, the method 200 may further include attaching the power adapter 152 to the computing device 154, and when attached, carrying the computing device 154 by the power adapter 152 serving as a handle. The method 200 may further include detaching the power adapter 152 from the computing device 154, and when detached, disposing or extending the power adapter 152 away from the computing device 154 by a distance less than or equal to a length of the multi-functional cable 160.

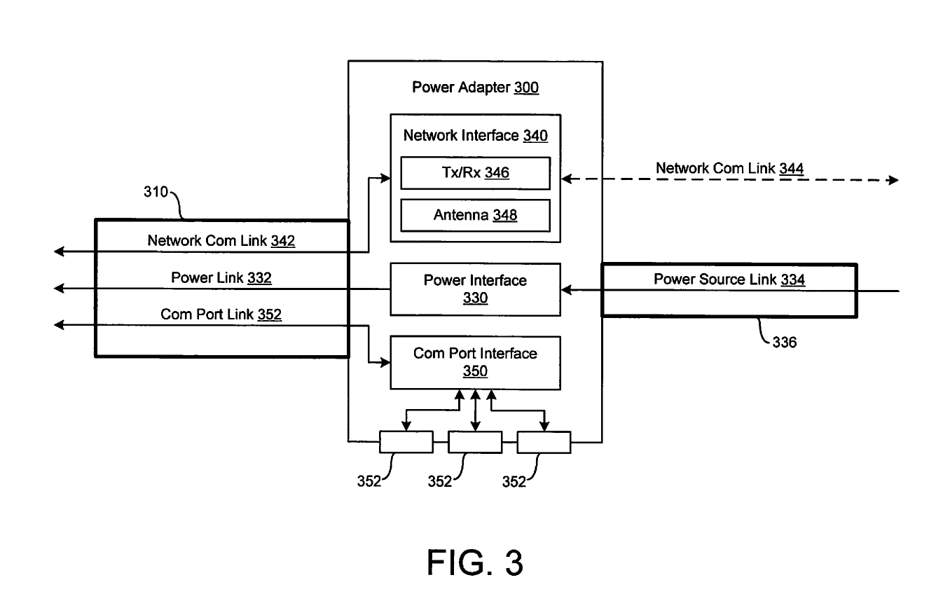

FIG. 3 is a block diagram illustrating an example power adapter 300 suitable for implementing embodiments of the disclosure, including the power adapters 102, 152 of FIGS. 1A-1D.

In the example of FIG. 3, the power adapter 300 may be configured for a portable computing device (e.g., computing devices 104, 154) having at least one processor (e.g., the at least one processor 120). In various implementations, as described herein, the portable computing device may comprise at least one of a laptop computer, a notebook computer, a tablet computer, a PDA, a PC, and a mobile phone.

The power adapter 300 may include a power interface 330 (e.g., the power interface 112) for supplying power to the portable computing device including the at least one processor via a multi-functional cable 310 (e.g., the multi-functional cables 110, 160) interposed between the power adapter 300 and the portable computing device.

The power adapter 300 may include a network interface 340 (e.g., the network interface 114) for communicating with the at least one processor via the multi-functional cable 310 and a remote server (e.g., the remote server 130) over a wireless network (e.g., the wireless network 132). In an implementation, as described herein, the wireless network may comprise one or more wireless communication networks adapted to communicate with one or more other wired or wireless networks including the Internet.

The multi-functional cable 310 may be configured with a first transitory medium 332 (e.g., the first transitory medium 122) for supplying power to the portable computing device from the power interface 300 and a first transitory medium 342 for transferring information between the portable computing device and the network interface 340. The first transitory medium 332 may be referred to as a power link between the portable computing device including the at least one processor and the power interface 330 of the power adapter 300. The first transitory medium 342 may be referred to as a network communication link between the portable computing device including the at least one processor and the network interface 340 of the power adapter 300. The power adapter 300 may be configured to be disposed or extended away from the portable computing device by a distance less than or equal to a length of the multi-functional cable 310.

In reference to the examples of FIGS. 1A-3, the at least one processor of the portable computing device may be configured to communicate with the remote server via the network interface 340 of the power adapter 300 by transferring information over the first transitory medium 342 of the multi-functional cable 310 to the network interface 340, and the network interface 340 may be configured for transferring the information received from the at least one processor to the remote server over the wireless network via a network communication link 344 and at least one antenna 348. In an example, the antenna 348 may comprise an internal antenna positioned within the power adapter 300. In another example, the antenna 348 may comprise an external antenna positioned outside the power adapter 300.

The multi-functional cable 310 may be configured to enclose the first and second transitory mediums 332, 342, and the first transitory medium 332 may be separate from the first transitory medium 342. The first transitory medium 332 may comprise first wiring for supplying power to the portable computing device including the at least one processor from the power interface 330 of the power adapter 300 via the multi-functional cable 310. The first transitory medium 342 may comprise second wiring for transferring information between the portable computing device including the at least one processor and the network interface 340 of the power adapter 300 via the multi-functional cable 310. The first transitory medium 332 may comprise first shielded wiring, and the first transitory medium 342 may comprise second shielded wiring, wherein the first transitory medium 332 may be shielded separately from the first transitory medium 342.

The network interface 340 of the power adapter 300 may be configured to transmit and receive wired communication signals to and from the portable computing device over the first transitory medium 342 of the multi-functional cable 310. The network interface 340 of the power adapter 300 may include one or more communication components 346 including at least one of a transceiver, a transmitter, and a receiver, and the antenna 348 to communicate with the remote server over the wireless network via the network communication link 344. The network interface 340 of the power adapter 300 may be configured to transmit and receive wireless radio frequency (RF) communication signals to and from the remote server over the wireless network via the network communication link 344 and the antenna 348. In various implementations, the one or more communication components 346 of the network interface 340 (e.g., one or more of a transceiver, a transmitter, and a receiver, and the antenna 348) may be configured as internal or external components or some combination thereof, without departing from the scope of the disclosure.

The power interface 330 of the power adapter 300 may be configured as a power converter adapted to transform an alternating current (AC) power signal received from an alternating current (AC) power source via a power cable 336 (e.g., the power cable 142, 192) to a direct current (DC) power signal for supplying to the portable computing device including the at least one processor via the first transitory medium 332 of the multi-functional cable 310. In an implementation, the power source link 334 is configured to be coupled or plugged into a standard power outlet. For example, referring to FIG. 1B, the power source link 334 may comprise a power cable, such as the power cable 142 having the plug 144 for electrically connecting to the power source 140, such as, for example, a household outlet plug.

The power adapter 300 may be configured for attaching to the portable computing device, and when attached, the power adapter 300 may serve as a handle for carrying the portable computing device by a user. The power adapter 300 may be configured for detaching from the portable computing device, and when detached, the power adapter 300 may be configured to be disposed or extended away from the portable computing device by a distance less than or equal to a length of the multi-functional cable 310.

In the example of FIG. 3, the power adapter 300 may further include a communication port interface 350 for communicating with the at least one processor via the multi-functional cable 310. The multi-functional cable 310 may be configured with a third transitory medium 352 for transferring information between the portable computing device and the communication port interface 350 including one or more ports 352, such as, for example, one or more of a USB port, an Ethernet port, a firewire port, a serial port, a parallel port, and a DVI port. The third transitory medium 352 may be referred to as a power link between the portable computing device including the at least one processor and the communication port interface 350 of the power adapter 300. The multi-functional cable 310 may be configured to enclose the first, second, and third transitory mediums 332, 342, 352, and the third transitory medium 352 may separate from the first and second transitory mediums 332, 342. The third transitory medium 352 may comprise third wiring for transferring information between the portable computing device and the communication port interface 350 of the power adapter 300 via the multi-functional cable 300. The third transitory medium 352 may comprise third shielded wiring, and the third transitory medium 352 may be shielded separately from the first and second transitory mediums 332, 342.

In an implementation, the interfaces 330, 340, 350 may comprise separate components positioned within the power adapter 300. However, it should be appreciated that, even though the interfaces 330, 340, 350 are shown as separate components, two or more of the interfaces 330, 340, 350 may be integrated as a single component without departing from the scope of the disclosure.

The power adapter 300 may include a charger or charging component configured for supplying charge power to a power storage component (e.g., a battery) of the portable computing device via the multi-functional cable 310. For example, the power interface 330 of the power adapter 300 may include a charger or charging component configured for supplying charge power to a battery of the portable computing device via the first transitory medium 332 of the multi-functional cable 310.

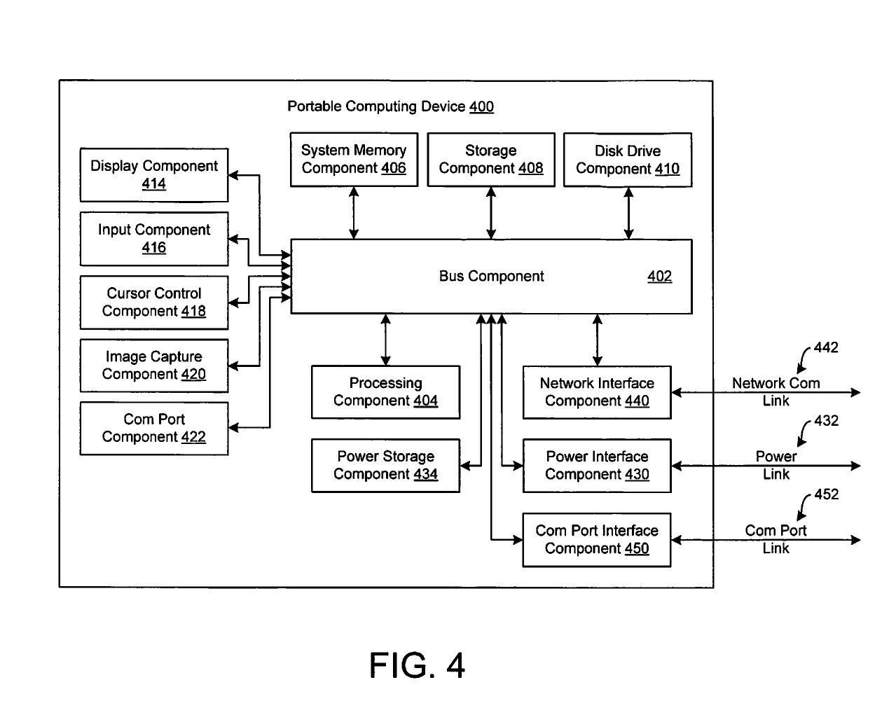

FIG. 4 is a block diagram illustrating an example computer system, such as, for example, a portable computing device 400, suitable for implementing one or more embodiments of the disclosure, including the computing devices 104, 154 of FIGS. 1A-1D, which may be configured as portable computing devices. For instance, the portable computing device 400 may be implemented using any appropriate combination of hardware and/or software configured for interfacing with a user including a user device, a user interface (UI) device, a user terminal, a client device, or a customer device. The portable computing device 400 may be implemented, in various examples, as at least one of a portable computer, a laptop computer, a notebook computer, a tablet computer, or a PDA. In another example, the portable computing device 400 may be implemented as some other type of computing device adapted for interfacing with a user, such as, for example, a PC. In another example, the portable computing device 400 may be implemented as a portable communication device (e.g., a mobile phone, a smart phone, a wireless cellular phone, etc.) adapted for interfacing with a user and for wireless communication over one or more wireless networks including a mobile communications network, WLAN, Wi-Fi, etc., and the Internet.

The portable computing device 400 may include a network interface component 440 for wirelessly communicating with a network server (e.g., the remote server 130) over a network (e.g., the wireless network 132) via a network communication link 442 established with the network server using any known wireless communications technologies and protocols including radio frequency (RF), microwave frequency (MWF), and/or infrared frequency (IRF) wireless communications technologies and protocols adapted for communication over the network. In accordance with an aspect of the disclosure, the portable computing device 400 may be configured to communicate with the network server, for example, via the power adapter 300 of FIG. 3, wherein information may be transferred with the network server via communication between the network interface 440 over the network communication link 442 via the second transitory medium 342 of the multi-functional cable 310, the network interface 340 of the power adapter 300, and the antenna 348. In an implementation, the second transitory medium 342 of the multi-functional cable 310 may be configured to establish the network communication link 442 between the power adapter 300 and the portable computing device 400 so as transfer information from the portable computing device 400 to the network server via the power adapter 300.

In accordance with aspects of the disclosure, the portable computing device 400 may include a bus 402 or other communication mechanism for communicating information, which interconnects subsystems and components, such as, for example, at least one processor 404 (e.g., processor, micro-controller, digital signal processor (DSP), etc.), system memory component 406 (e.g., RAM), static storage component 408 (e.g., ROM), disk drive component 410 (e.g., magnetic or optical), one or more network interface components 440 (e.g., modem, Ethernet card, RF ID reader, RF and/or IRF transceiver, RF and/or IRF transmitter, and/or RF and/or IRF receiver), display component 414 (e.g., CRT or LCD), input component 416 (e.g., keyboard), cursor control component 418 (e.g., mouse or trackball), image capture component 420 (e.g., analog or digital camera, scanner, barcode reader), communication port component 422 (e.g., USB port, an Ethernet port, a firewire port, a serial port, a parallel port, a DVI port, etc.), and a power storage component 434 (e.g., a battery). In an implementation, disk drive component 410 may comprise one or more databases with each database having at least one or more disk drive components.

The portable computing device 400 may include a power interface component 430 for receiving power from the power adapter 300 of FIG. 3 via a power link 432 established with the power adapter 300 via the multi-functional cable 310. In accordance with an aspect of the disclosure, the portable computing device 400 may be configured to receive power from the network adapter 300 of FIG. 3, wherein power may be supplied by the power adapter 300 via the first transitory medium 332 of the multi-functional cable 310, in a manner, for example, as described in reference to FIG. 3. In an implementation, the first transitory medium 332 of the multi-functional cable 310 may be configured to establish the power link 432 between the power adapter 300 and the portable computing device 400.

The portable computing device 400 may include a communication port interface component 450 for communicating with the communication port interface 350 of the power adapter 300 of FIG. 3 via a communication port link 452 established with the power adapter 300 via the multi-functional cable 310. In accordance with an aspect of the disclosure, the portable computing device 400 may be configured to communicate with the communication port interface 350 of the network adapter 300 of FIG. 3, wherein information may be transferred with the ports 352 of the power adapter 300 via the third transitory medium 352 of the multi-functional cable 310 and the communication port interface 350 of the power adapter 300, in a manner, for example, as described in reference to FIG. 3. In an implementation, the third transitory medium 352 of the multi-functional cable 310 may be configured to establish the communication port link 432 between the power adapter 300 and the portable computing device 400.

In accordance with embodiments of the disclosure, the portable computing device 400 may be configured to perform specific operations by the at least one processor 404 executing one or more sequences of one or more instructions contained in system memory component 406. Such instructions may be read into system memory component 406 from another computer readable medium, such as static storage component 408 or disk drive component 410. In other embodiments, hard-wired circuitry may be used in place of or in combination with software instructions to implement the disclosure.

Logic may be encoded in a computer readable medium, which may refer to any medium that participates in providing instructions to the at least one processor 404 for execution. Such a medium may take many forms, including but not limited to, non-volatile media and volatile media. In various implementations, non-volatile media may include optical or magnetic disks, such as disk drive component 410, and volatile media may include dynamic memory, such as system memory component 406. In an aspect, data and information related to executing instructions may be transmitted to portable computing device 400 via a transmission media, such as in the form of acoustic or light waves, including those generated during radio wave and infrared data communications. In various implementations, transmission media may include coaxial cables, copper wire, and fiber optics, including wires that comprise bus 402.

Some common forms of non-transitory computer readable media may include, for example, floppy disk, flexible disk, hard disk, magnetic tape, any other magnetic medium, CD-ROM, any other optical medium, punch cards, paper tape, any other physical medium with patterns of holes, RAM, PROM, EPROM, FLASH-EPROM, any other memory chip or cartridge, carrier wave, or any other medium from which a computer is adapted to read.

In various implementations, execution of instruction sequences may be performed by the portable computing device 400. In various other implementations, a plurality of computer systems 400 coupled by network communication link 442 (e.g., a wired and/or wireless network, such as a LAN, WLAN, PTSN, and/or various other wired or wireless networks, including telecommunications, mobile, and cellular phone networks) may perform instruction sequences in coordination with one another.

In an implementation, the portable computing device 400 may transmit and receive messages, data, information and instructions, including one or more programs (i.e., application code) through network communication link 442 and network interface component 440. In an example, received program code may be executed by the at least one processor 404 as received and/or stored in disk drive component 410 or some other non-volatile storage component for execution.

In an implementation, processors suitable for the processing of a computer program include, by way of example, both general and special purpose microprocessors, and any one or more processors of any kind of a digital computer. A processor may receive instructions and data from a read-only memory or a random access memory or both. Elements of a computer may include at least one processor for executing instructions and one or more memory devices for storing instructions and data. A computer also may include, or be operatively coupled to receive data from or transfer data to, or both, one or more mass storage devices for storing data (e.g., magnetic, magneto-optical disks, or optical disks). Information carriers suitable for embodying computer program instructions and data include all forms of non-volatile memory, including by way of example semiconductor memory devices (e.g., EPROM, EEPROM, and flash memory devices); magnetic disks (e.g., internal hard disks or removable disks); magneto-optical disks; and CD-ROM and DVD-ROM disks. The processor and the memory may be supplemented by, or incorporated in special purpose logic circuitry.

Implementations may be implemented in a computing system that may include a back-end component (e.g., as a data server), or that may include a middleware component (e.g., an application server), or that may include a front-end component (e.g., a client computer having a graphical user interface or a Web browser) through which a user may interact with an implementation, or any combination of such back-end, middleware, or front-end components. Components may be interconnected by any form or medium of digital data communication (e.g., communication network). Examples of communication networks include a local area network (LAN) (e.g., an intranet) and a wide area network (WAN) (e.g., the Internet).

While certain features of described implementations have been illustrated as described herein, many modifications, substitutions, changes and equivalents will now occur to those skilled in the art. It is, therefore, to be understood that the appended claims are intended to cover all such modifications and changes as fall within the scope of the implementations. It should be understood that they have been presented by way of example only, not limitation, and various changes in form and details may be made. Any portion of the apparatus and/or methods described herein may be combined in any combination, except mutually exclusive combinations. The implementations described herein may include various combinations and/or sub-combinations of the functions, components and/or features of the different implementations described.

What is claimed is:

1. A power adapter for a computing device having at least one processor, comprising:
a power interface for supplying power to the computing device including the at least one processor via a multi-functional cable interposed between the power adapter and the computing device; and
a network interface for communicating with the at least one processor via the multi-functional cable and a remote server over a wireless network,
wherein the multi-functional cable is configured with a first transitory medium for supplying power to the computing device from the power interface and a second transitory medium for transferring information between the computing device and the network interface.

2. The power adapter of claim 1, wherein the power adapter is configured to be disposed away from the computing device by a distance of less than or equal to a length of the multi-functional cable.

3. The power adapter of claim 1, wherein the at least one processor of the computing device is configured to communicate with the remote server via the network interface of the power adapter by transferring information over the second transitory medium of the multi-functional cable to the network interface, and the network interface transferring the information received from the at least one processor to the remote server over the wireless network.

4. The power adapter of claim 1, wherein the multi-functional cable is configured to enclose the first and second transitory mediums, and the first transitory medium is separate from the second transitory medium.

5. The power adapter of claim 1, wherein:
the first transitory medium comprises first wiring for supplying power to the computing device including the at least one processor from the power interface of the power adapter via the multi-functional cable, and
the second transitory medium comprises second wiring for transferring information between the computing device including the at least one processor and the network interface of the power adapter via the multi-functional cable.

6. The power adapter of claim 1, wherein:
the first transitory medium comprises first shielded wiring; and
the second transitory medium comprises second shielded wiring,
wherein the first transitory medium is shielded separately from the second transitory medium.

7. The power adapter of claim 1, wherein the network interface of the power adapter is configured to transmit and receive wired communication signals to and from the computing device over the second transitory medium of the multi-functional cable.

8. The power adapter of claim 1, wherein the network interface of the power adapter comprises one or more communication components including at least one of a transceiver, a transmitter, a receiver, and an antenna to communicate with the remote server over the wireless network.

9. The power adapter of claim 1, wherein the network interface of the power adapter is configured to transmit and receive wireless radio frequency (RF) communication signals to and from the remote server over the wireless network.

10. The power adapter of claim 1, wherein the power interface of the power adapter is configured as a power converter adapted to transform an alternating current power signal received from an alternating current power source via a power cable to a direct current power signal for supplying to the computing device including the at least one processor via the first transitory medium of the multi-functional cable.

11. The power adapter of claim 1, wherein:
the power adapter is configured for attaching to the computing device, and
when attached, the power adapter serves as a handle for carrying the computing device by a user.

12. The power adapter of claim 11, wherein:
the power adapter is configured for detaching from the computing device, and
when detached, the power adapter is configured to be disposed away from the computing device by a distance less than or equal to a length of the multi-functional cable.

13. The power adapter of claim 1, further comprising a communication port interface for communicating with the at least one processor via the multi-functional cable, wherein:
the multi-functional cable is configured with a third transitory medium for transferring information between the computing device and the communication port interface including one or more of a universal serial bus (USB) port, an Ethernet port, a firewire port, a serial port, a parallel port, and a digital visual interface (DVI) port,
the multi-functional cable is configured to enclose the first, second, and third transitory mediums, and the third transitory medium is separate from the first and second transitory mediums,
the third transitory medium comprises third wiring for transferring information between the computing device and the communication port interface of the power adapter via the multi-functional cable,
the third transitory medium comprises third shielded wiring, and
the third transitory medium is shielded separately from the first and second transitory mediums.

14. The power adapter of claim 1, wherein the power adapter comprises a charger configured for supplying charge power to a battery of the computing device via the multi-functional cable.

15. The power adapter of claim 1, wherein the computing device comprises a portable computing device including at least one of a laptop computer, a notebook computer, and a tablet computer.

16. The power adapter of claim 1, wherein the wireless network comprises a wireless communication network adapted to communicate with the Internet.

17. A system comprising:
a computing device comprising at least one processor;
a multi-functional cable comprising a first transitory medium for supplying power to the computing device and a second transitory medium for transferring information with the computing device; and
a power adapter comprising a power interface for supplying power to the computing device including the at least one processor via the first transitory medium of the multi-functional cable when interposed between the computing device and the power adapter, the power adapter further comprising a network interface for communicating with the at least one processor via the second transitory medium of the multi-functional cable and a remote server via a wireless network,
wherein the multi-functional cable electrically connects the computing device to the power interface of the power adapter via the first transitory medium for supplying power to the computing device from the power interface, and
wherein the multi-functional cable electrically connects the computing device to the network interface of the power adapter via the second transitory medium for transferring information between the computing device and the network interface.

18. The system of claim 17, wherein the power adapter is configured to be disposed away from the computing device by a distance less than or equal to a length of the multi-functional cable.

19. A method comprising:
assembling a power adapter with a power interface and a network interface for use by a computing device having at least one processor; and
assembling a multi-functional cable having a plurality of transitory mediums for electrically connecting between the power adapter and the computing device, wherein the multi-functional cable provides for supplying power to the computing device including the at least one processor from the power interface of the power adapter via a first transitory medium of the multi-functional cable when interposed between the computing device and the power adapter,
wherein the multi-functional cable provides for communicating between the at least one processor of the computing device and the network interface of the power adapter via a second transitory medium of the multi-functional cable, and
wherein the multi-functional cable provides for communicating between a remote server and the computing device via the second transitory medium of the multi-functional cable and the network interface of the power adapter over a wireless network.

20. The method of claim 19, wherein the power adapter is configured to be disposed away from the computing device by a distance less than or equal to a length of the multi-functional cable.
